(19) United States
(12) Patent Application Publication
(10) Pub. No.: US 2023/0354855 A1
(43) Pub. Date: Nov. 9, 2023

(54) PROCESS FOR PRODUCING AN ENRICHED FIBER BEVERAGE

(71) Applicant: PURE FIBER GLOBAL, Bentonville, AR (US)

(72) Inventor: Martin Ruette

(21) Appl. No.: 18/040,384

(22) PCT Filed: Aug. 20, 2021
(86) PCT No.: PCT/US2021/046891

§ 371 Date: Feb. 2, 2023

Related U.S. Application Data
(60) Provisional application No. 63/115,864, filed on Nov. 19, 2020.
(60) Provisional application No. 63/068,657, filed on Aug. 21, 2020.

(51) Int. Cl. A23L 2/60; A23L 2/38; A23L 31/00; A23L 2/68

(52) U.S. Cl. CPC A23L 2/382; A23L 2/60; A23L 2/68; A23L 31/00

(57) ABSTRACT

The present disclosure concerns processes to produce a beverage solution with a prolonged shelf life that does not require pasteurization, refrigeration or other heat treatments during preparation or storage, as well as a beverage product with stable shelf life at room temperature that has not been pasteurized or subjected to any other form of heat treatment.

### RELATED APPLICATIONS

This application claims priority to U.S. Provisional Pat. Application 63/068,657, filed Aug. 21, 2020, and to U.S. Provisional Pat. Application 63/115,864, filed Nov. 19, 2020, the contents of both of which are hereby incorporated by reference in their entirety.

### FIELD

The present disclosure relates to processes for producing a fiber enriched beverage. The processes provide a beverage with sustained shelf life without the need for pasteurization, heat treatment, or refrigeration.

### BACKGROUND

Commercially available beverages are used by many on a daily basis as a primary source of nutrition and hydration. Many of these beverages contain essential vitamins, fibers, saccharides, carbohydrates, proteins and more that readily contribute to the consumer’s well-being. Beverages with these sort of ingredients, however, are prone to microbial contamination and growth, particularly as microorganisms can thrive in the nutritious environment of the desirable beverage formulations. The advent of pasteurization historically solved these problems and ushered in an era of drastically improved consumer safety, providing steps to prevent microbe growth and render products safer for consumption. With pasteurization products were finally able sustain a significant shelf life, allowing for broader commercial distribution and large scale production of goods.

Pasteurization techniques, however, rely on heat to stifle microbial growth. Exposure to heat can also negatively affect the contents of the product. For example, heat can cross-link, burn off, caramelize or oxidize many beverage ingredients. Therefore, there remains a need to provide a safe consumable beverage with a commercially acceptable shelf life that does not require exposure to heat or other such treatments to prevent microbial growth.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

The present disclosure is directed to processes for producing a beverage allowing for the storage thereof that does not require heat treatment, pasteurization and/or refrigeration.

In some aspects, the present disclosure concerns a process for producing a soluble fiber beverage by a particular order of steps, none of which include heat treatment, pasteurization and/or refrigeration at 4° C. or lower. In some aspects, the ordered steps include a) providing to a receptacle a volume of potable water; b) adding a mushroom extract to the volume; c) adding a soluble fiber to the volume; and d) adding an acidic component.

The mushroom extract optionally may include a fermented extract from Dacryopinax spathularia. In some aspects, the mushroom extract is added to the volume at a concentration of about 2 to about 8 parts per million (ppm). In certain aspects, the mushroom extract is added to the volume at a concentration of 3 ppm.

In some aspects of the present disclosure, the process may also include agitation of the solution as the beverage is made. Optionally, the volume is agitated after step a). Optionally, the volume is agitated at a rate of about 1500 revolutions per minute (rpm) to about 3500 rpm. Optionally, the volume is agitated at a rate of 300 rpm or 3000 rpm.

In some aspects, the process may include intermediate steps. Optionally, an intermediate step may include a pause or delay to allow for the production of the beverage to proceed effectively. Optionally, the process may include introducing a pause is between steps b) and c) to allow for dissipation of foam. In some aspects, the period of time for a pause is about 10 to about 20 minutes. Optionally, the pause is about 15 minutes.

In some aspects, the process of producing the beverage requires the introduction of a soluble fiber as part of step c). Optionally, the soluble fiber is selected from inulin, polydextrose and polydextrose polyols, fructooligosaccharide or oligofructose, mucilage, beta-glucans, pectin, gums, psyllium, resistant starch, wheat dextrin, or combinations thereof. Optionally, the soluble fiber is selected from polydextrose, inulin, fructooligosaccharide or combinations thereof. Optionally, the soluble fiber is polydextrose.

In some aspects, the processes of the present disclosure include adding components to the solution at certain mass to volume. Optionally, soluble fiber is added at a mass to allow for efficient solubilization. In certain aspects, 16.6 kilograms (kg) of soluble fiber is added for every 1000 liters of water.

In some aspects, the acidic component is citric acid, citrus juice, tartaric acid, ascorbic acid, acetic acid, or combinations thereof. Optionally, the acidic component is citric acid. In some aspects, about 646 grams (g) of the citric acid is added for every 1000 liters of beverage solution. In other aspects, the acidic component is added until a pH of about 3.6 to about 3.9 is obtained.

In some aspects, the water utilized in the process should be of sufficient quality to be safely consumed by a human. In certain aspects, the water is obtained by reverse osmosis, distillation or from a natural or artificial spring.

In other aspects of the processes, additional step(s) may follow after step d). In some aspects, the one or more additional steps may include adding a sweetener. Optionally, the sweetener is selected from sugar, glucose, fructose, galactose, sucrose, honey, agave, erythritol, monk fruit, stevia, allulose, deionized grape juice, coconut palm sugar, maple syrup, sucralose, aspartame, saccharin or combinations thereof. Optionally, the sweetener includes a stevia. In Optionally, the stevia includes rebaudioside A. In some aspects, about 65.625 g of the sweetener is added for every 1000 liters of water.

In some aspects, the one or more additional steps include adding a flavoring agent and/or an aroma agent. Optionally, the flavoring agent is pineapple, mint, pomegranate, orange, lime, passion fruit, apple, papaya, peach, hog-plum, mango, strawberry, hibiscus, grape, banana, peach, apricot, grapefruit, blueberry, cranberry, kiwi, lemon, hibiscus, coconut, watermelon, cherry, raspberry or combinations thereof. Optionally, the flavor is a combination of strawberry, kiwi, or combinations thereof. In some aspects, the aroma agent is an aroma masking agent. Optionally, the aroma agent includes NSF-09. In certain aspects, 24.61 g of NSF-09 is added for every 1000 liters of water.

In some aspects, the one or more additional steps include adding at least one vitamin. The at least one vitamin may be vitamin A, vitamin B3, vitamin B5, vitamin B6, vitamin B9, vitamin B12, vitamin C, vitamin D, vitamin E, vitamin K, thiamin, riboflavin, pantothenic acid, biotin, choline, calcium, chromium, copper, fluoride, iodine, iron, magnesium, manganese, molybdenum, phosphorous, selenium, zinc, potassium, sodium, chloride or combinations thereof. In other aspects, the at least one vitamin is selected from vitamin B9 (folic acid), vitamin B6 (pyridoxine), vitamin B3 (niacin), vitamin B5 (calcium pantothenate), or combinations thereof. In certain aspects, the at least one vitamin includes vitamin B9 (folic acid), vitamin B6 (pyridoxine), vitamin B3 (niacin) and vitamin B5 (calcium pantothenate). In other aspects, about 0.2 g of vitamin B9 is added for every 1000 liters of water. In further aspects, about 3.9 g of vitamin B5 is added for every 1000 liters of water. In even further aspects, about 12.3 g of vitamin B3 is added for every 1000 liters of water. In further still aspects, about 1.025 g of vitamin B6 is added for every 1000 liters of water.

In some aspects of the processes, the pH of the soluble fiber beverage is checked or adjusted to be of about 3.6 to about 3.9. In other aspects, the Brix value of the soluble fiber beverage is checked or adjusted to be of about 2.4 to about 2.7. In further aspects, the acidity value of the soluble fiber beverage is checked or adjusted to be of about 0.05 to about 0.07.

In some aspects, the process of the present disclosure may include adding dimethyldicarbonate (DMDC). In further aspects, DMDC is added at a concentration of about 125 to about 238 ppm

In some aspects, the present disclosure concerns a soluble fiber beverage prepared by the processes described herein. In other aspects, the present disclosure concerns a soluble fiber beverage that includes about 0.2 mg/L of folic acid, 3.8 mg/L of vitamin B5, 12 mg/L of vitamin B3, 1 mg/L of vitamin B6, 630 mg/L of citric acid, 64 mg/L of rebaudioside A, 24 mg/L of aroma masking NSF-09, 1 g/L of a flavoring agent and about 15 to about 17 g/L of polydextrose or other soluble fiber, wherein the beverage is stable at room temperate and does not require refrigeration for a period of up to at least 3 months.

### BRIEF DESCRIPTION OF THE DRAWINGS

FIG. 1 shows an overview of the steps available to produce a soluble fiber enriched beverage solution according to some aspects as described hereing, including the steps that are required and those that are optional or that can be performed in a different order than as presented. Notably absent from the outlined process are steps of pasteurization, heat and/or pressure treatment, and refrigeration.

### DETAILED DESCRIPTION

The present disclosure concerns processes to produce a beverage solution with a prolonged shelf life that does not require pasteurization, refrigeration or other heat treatments, as well as a beverage product with stable shelf life at room temperature that has not been pasteurized or subjected to any other form of heat treatment.

In some aspects, the present disclosure provides processes to produce a beverage solution with prolonged shelf life that does not require any temperature treatment such as elevated temperature exposure illustratively those used for pasteurization or heat treatments, or lowered temperatures such as those used for common refrigeration. In some aspects, the processes and the storage of the produced beverage solution may occur at ambient or room temperature (e.g. 25° C., optionally ± 5° C.). Optionally, the process and subsequent beverage storage can are at a temperature above refrigeration temperatures of 4° C. Optionally, the process and subsequent beverage storage are at temperatures below 50° C. Optionally, the process and subsequent beverage storage can occur at a temperature from about 10° C. to about 40° C., including about 11, 12, 13, 14, 15, 16, 17, 18, 19, 20, 21, 22, 23, 24, 25, 26, 27, 28, 29, 30, 31, 32, 33, 34, 35, 36, 37, 38 and39° C. In other aspects, the process can occur at about 15° C. to about 30° C.

The processes as provided herein produce a beverage solution has a bottled shelf life of at least three months. As used herein, “bottled” may refer to a sealed or closed containment of the beverage solution, such as in a bottle, can, carton, jar, box, or similar. In some aspects, the prepared and bottled beverage has a shelf life of about three to about nine months. Optionally, the prepared and bottled beverage has a shelf life of about six to about nine months. In other aspects, the beverage has a bottled shelf life of about nine months or longer. The process and the beverage solution do not include pasteurization or other heat or pressure treatments. The process and the beverage solution do not include refrigeration either during the process itself or for storage of the bottled beverage until consumption.

As used herein, the term “shelf life” means that the beverage remains safe for human consumption during the time defined by the shelf life. A product will have a shelf life as defined by the absence of detectable levels of one or more particular active contaminants such as E. coli, listeria monocytogenes, or other contaminant per standards of the U.S. Food and Drug Administration.

As used herein, the term “soluble” with respect to a soluble fiber means that the fiber has the physical characteristics and concentration such that the fiber will dissolve in water to form a substantially homogenous solution as illustrated by the absence of visible particles/precipitates. Solubility is defined by IUPAC as the analytical composition of a saturated solution expressed as a proportion of a designated solute in a designated solvent. IUPAC, Compendium of Chemical Terminology, 2nd ed. (the “Gold Book”) (1997).

In some aspects, the present disclosure provided a process for producing a beverage that is a series of steps to produce the beverage solution. In certain aspects, the processes include at least four or five steps to produce a beverage with the desired shelf life. In further aspects, the processes require at least four of the steps in an ordered sequence. In further aspects, the four or five steps may be followed by additional, optional steps to achieve a bottled beverage with enriched soluble fiber and desired shelf life at ambient or room temperatures.

In some aspects, the process includes an optional first step of obtaining or measuring or massing or preparing the appropriate weights and/or volumes and/or masses and/or sizes and/or quantities of ingredients to be added and/or included in a final beverage solution to be bottled. In some aspects, the required quantities of ingredients needed are acquired and/or prepared for a final per volume of beverage solution. In some aspects, vitamins, soluble fiber, citric acid or similar, flavorings, aromas and/or sweeteners are prepared by mass to the desired final volume of beverage solution to be bottled. It will be appreciated by those skilled in the art that the amounts of each can be scaled based on the desired final volume of the beverage solution. In one aspect of the present disclosure, the process does not result in loss or conversion of any of the ingredients added in a final beverage solution and/or bottled beverage except for soluble fiber. For example, as set forth herein, due to the lack of pasteurization or other heat or other sterilization and/or aseptic procedures, there is only of up to about 10% loss of soluble fiber due to conversion into carbohydrate from all ingredients added to the beverage solution, including substantially no loss of vitamins, sweeteners, sugars, mushroom extract, citric acid and the like.

In some aspects, the ingredients to be prepared during the first step may include soluble fiber, mushroom extract, vitamins and minerals, flavorings, aromas, and/or sweeteners. In other aspects, an antimicrobial and/or antifungal agent may also be prepared.

In some aspects, vitamins and minerals can be prepared to be present in the final beverage product. As described herein, the process does not provide for significant loss of any ingredient added due to the lack of temperature treatments and the like. Accordingly, in some aspects, the amount of any vitamin or mineral added may be limited with regard to maximum daily doses allowed or with regard to significantly exceeding recommended daily dose amounts. Examples of vitamins and minerals may include vitamin A, vitamin B3, vitamin B5, vitamin B6, vitamin B9, vitamin B12, vitamin C, vitamin D, vitamin E, vitamin K, thiamin, riboflavin, pantothenic acid, biotin, choline, calcium, chromium, copper, fluoride, iodine, iron, magnesium, manganese, molybdenum, phosphorous, selenium, zinc, potassium, sodium, and chloride. In certain aspects, vitamins prepare to be added to the beverage solution may include vitamin B9 (folic acid), vitamin B6 (pyridoxine), vitamin B3 (niacin) and vitamin B5 (calcium pantothenate).

Optionally, vitamin B9 is added to about 0.2 g/1000 L of beverage solution or 1.6 g/8000 L of beverage solution. In other aspects, vitamin B5 is added to about 3.9 g/1000 L of beverage solution or 31.2 g/8000 L of beverage solution. In further aspects, vitamin B3 is added to about 12.3 g/1000 L of beverage solution or 98.4 g/8000 L of beverage solution. In other aspects, vitamin B6 is added to about 1.025 g/1000 L of beverage solution or 8.2 g/8000 L of beverage solution.

One or more sweeteners may be added to the beverage solution. Sweeteners may include sugar, glucose, fructose, galactose, sucrose, honey, agave, erythritol, monk fruit, stevia, allulose, deionized grape juice, coconut palm sugar, maple syrup, sucralose, aspartame, saccharin or combinations thereof. In some aspects, the sweeteners may include a stevia, such as rebaudioside A, aspartame, sodium saccharin, or a combination thereof. In some aspects, the sweetener is added to about 65.625 g/1000 L of beverage solution or about 525 g/8000 L of beverage solution. For example, 65.625 g of rebaudioside A may be added for every 1000 L of beverage solution prepared.

In further aspects, aromas or aroma-masking agents may be prepared to be added to the beverage solution. Those skilled in the art that such agents may reduce or disguise the aroma of the beverage solution or provide a particular aroma to the beverage solution. In some aspects, such agents may provide a sweet aroma, such that fewer sweeteners may be required or desired in the beverage. In some aspects, aroma masking agents may included, such as a molasses aroma (e.g. NSF-09), optionally at about 24.61 g/1000 L of beverage solution or about 196.9 g/8000 L of beverage solution. In further aspects, flavorings may be included to about 1.025 kg/1000 L of beverage solution or about 8.2035 kg/8000 L of beverage solution.

In other aspects, a flavoring agent may be included in the beverage solution. Flavoring agents may include fruit juices, extracts or artificial fruit flavors. It will be appreciated by those skilled in the art that the flavoring agent may be included to associate the beverage product with a particular fruit, flower, plant or combinations thereof such that the bottled beverage reminds or resembles a taste and/or smell associated with natural products. In some aspects, the flavor may be selected from pineapple, mint, pomegranate, orange, lime, passion fruit, apple, papaya, peach, hog-plum, mango, strawberry, hibiscus, grape, banana, peach, apricot, grapefruit, blueberry, cranberry, kiwi, lemon, hibiscus, coconut, watermelon, cherry, raspberry or combinations thereof. In other aspects, the flavor is a combination of strawberry and kiwi.

A beverage solution as provided herein inludes one or more soluble fibers. A soluble fiber may be prepared and/or massed and/or measured to be added to the beverage solution. Soluble fibers may include inulin, polydextrose and polydextrose polyols, fructooligosaccharide or oligofructose, mucilage, beta-glucans, pectin, gums, psyllium, resistant starch, wheat dextrin, or combinations thereof. In some aspects, the soluble fiber added may be selected from polydextrose, inulin and/or fructooligosaccharide. In other aspects, the soluble fiber may be polydextrose. In further aspects, the soluble fiber may be added to about 16.6 kg/1000 L of beverage solution or about 133.3 kg/8000 L of beverage solution. For example, 16.6 kg of polydextrose may be added for every 1000 L of beverage solution to be prepared. As described herein, it can be expected that in some instances approximately 10% of soluble fiber will be lost during the production process as provided herein. Accordingly, in some instances where about 16.6 kg/1000 L of soluble fiber added, it may be expected to provide a final beverage solution or bottled beverage with about 15 g/L of soluble fiber dissolved therein.

A pH reducing or buffering agent may be included in a beverage solution to stabilize the beverage solution at a stable acidic pH. In certain aspects, citric acid or a similar pH reducing agent may be prepared to achieve the desired pH, such as a citrus juice, tartaric acid, ascorbic acid, or acetic acid. In some aspects, sufficient citric acid to obtain a final pH of between about 3.6 to about 3.9 may be included. In some aspects, about 646 g of acid/1000 L of beverage solution or about 5.1682 kg of acid /8000 L of beverage solution may be prepared to provide a bottled beverage and a beverage solution with an acidic pH of from about 3.6 to about 3.9 or from about 3.0 to about 4.1. Those skilled in the art will appreciate that as set forth herein, further acidic compounds or amounts of acid compound may be added to adjust the pH as necessary prior to bottling to ensure the pH lies within from about 3.6 to about 3.9 or from about 3.0 to about 4.1. For example, following addition of all ingredients, in some aspects, checking the pH may be desirable or required. In such instances, it may be necessary to add acidic or alkaline agents to bring the pH to within from about 3.6 to about 3.9 or from about 3.0 to about 4.1. As an example, those skilled in the art will appreciate that different water sources may provide a varying pH and as such, the amount of citric acid or similar may vary accordingly to achieve a pH from about 3.6 to about 3.9 or from about 3.0 to about 4.1.

In some aspects, the first step of preparing ingredients is performed as a first sequential step of the process. It will be appreciated by those skilled in the art that preparation of the ingredients prior to production offers a convenience of preparedness. However, it may be further appreciated that each ingredient may be prepared, measured or massed at any point in time up until it is to be added in to the beverage solution. In some aspects, it is convenient to have all ingredients appropriately massed or measured to ensure the process can proceed unhindered. In other aspects, it will be appreciated that measuring, preparing, massing and the such of ingredients to be added can occur, in whole or in part, during other steps as set forth herein, up until the ingredients are to be added to the beverage solution. For example, as set forth herein, soluble fiber can be prepared, measured and/or massed up until such is added into the beverage solution. In further aspects, preparing ingredients for the beverage solution can occur simultaneously with or during other steps, particularly in instances where a step requires a period of time to occur, such as an incubation, or further when the process is being executed by more than one party. For example, ingredients may be measured or massed as a tank or a receptacle fills with the necessary volume of water required to prepare the beverage solution.

In some aspects, the process may include a second step of adding water to a receptacle or a tank at a sufficient volume to achieve the final volume of beverage solution desired. In some aspects, the second step can follow the first step. In other aspects, the second step can precede the first step. In even further aspects, the first step can occur during the same time as the second step. For example, in commercial endeavors that require a large volume of water, steps of preparing ingredients for the beverage solution can occur as a receptacle or a tank fills with the required volume of water. In some aspects, the tank or receptacle is sterilized or heat cleaned prior to its use during the processes disclosed herein. In other aspects, the tank or receptacle has a lid or cover to reduce exposure to the surrounding ambient atmosphere.

In other aspects, as the water is added, or optionally after all the water is added, the volume may be agitated or stirred. It will be appreciated by those skilled in the art that agitation or stirring may help or be required to assist or to achieve solubilization of dried or powdered ingredients in the beverage solution. In some aspects, the beverage solution is agitated using a blade or other device spinning at a rate of from about 1500 to about 3500 rpm. It may be recognized to those skilled in the art that a slower agitation rate may require extended periods of time for the ingredients to dissolve or solubilize. For example, in some instances, the water may be agitated at around 3000 rpm and the ingredients will be in solution in about 30 minutes (mins). In some aspects, the agitation is performed by stirring or shaking or combinations thereof. In some aspects, the stirring can be performed by a motorized paddle or blade or rod placed within the beverage solution. It will be appreciated by those skilled in the art that any object placed into the beverage solution to assist in the agitation thereof should be inert to the beverage solution and stable in pH conditions ranging from about 1 to about 8.

In some aspects, the water added is to be of a suitable quality for safe human consumption. In some aspects, the water added can be filtered, distilled, spring water or obtained through reverse osmosis (RO) or combinations thereof. In other aspects, the water is potable water. In certain aspects, the water is prepared by reverse osmosis, which may be referred to as “RO water.” In other aspects, the water is sourced from a natural spring. In some instances, the water may be assayed to determine the presence or level of impurities or contaminants therein. Following such, the water may be further treated or filtered prior to use or even in some instances rejected. It may be appreciated by those skilled in the art that due to the absence of temperature treatments, including pasteurization and/or refrigeration both during the process and for the produced beverage, a level of basic water purity may be desired and treatment of the water may be needed or desired prior to filling the tank or receptacle. Further treatment of the water to be supplied to the tank or receptacle may include distillation, sterilization, boiling, iodine treatment, reverse osmosis, filtration, chelation, coagulation, flocculation, sedimentation, disinfection or combinations thereof.

In further aspects with regard to the water quality or beverage solution quality, certain of the optional steps of the process following the addition of citric acid as described herein may become more desirable. For example, use of spring water may benefit from the addition of dimethyldicarbonate (DMDC), such as Velcorin or similar anti-fungal and/or antimicrobial additives, to assist in preserving shelf life. Those skilled in the art will also appreciate that water sources of higher purity may not require the optional steps. In other aspects, the process does not require the use of an aseptic line to provide water to the beverage solution. Those skilled in the art will further appreciate that any addition of an anti-fungal or anti-microbial compound may affect the pH of the beverage solution. Accordingly, in some instances, checking the pH after such addition may be desirable and it may further be necessary to readjust the pH to have the beverage solution be within the ranges as described herein.

In some aspects, the process may include a third step of adding a mushroom extract (or other extract that prevents bacterial contamination and bacterial growth) to the beverage solution. In some aspects, the third step follows sequentially from the optional first and the second step. In other aspects, the third step is at least sequential to the second step. In some aspects, the third step of the process includes the addition of a mushroom extract to the volume of the beverage solution. In other aspects, the mushroom extract is agitated, such as by stirring, into the beverage solution. As described herein, the second step includes adding water to a tank or a receptacle. Accordingly, the third step may further be viewed as adding a mushroom extract to the volume of water from the second step. In some aspects, the mushroom extract is provided as the product Nagardo by LANXESS. In some aspects, the mushroom extract is a fermented extract from a mushroom source. In some aspects, the mushroom source may include basidiomycetes, including Dacrymycetes. In further aspects, the mushroom source may include fungus from the genus of Dacryopinax, including Dacryopinax spathularia. In other aspects, the mushroom extract includes glycolipids from a mushroom source, such as glycolipids from Dacryopinax spathularia. In further aspects, the mushroom extract includes fermented glycolipids from a mushroom source, such as fermented glycolipids from Dacryopinax spathularia.

The mushroom extract may be added at about 2 ppm to about 8 ppm, including about 2, 3, 4, 5, 6, 7, and 8 ppm. In other aspects, a fermented glycolipid extract from Dacryopinax spathularia may be added to the beverage solution to provide a concentration of about 3 ppm.

In further aspects, there can be a delay or pause between adding the mushroom extract and proceeding to the next step. Adding the mushroom extract may result in foaming within the volume. In such instances, a process optionally includes a pause from the addition of further ingredients to allow for any foaming to dissipate before proceeding to the subsequent step. In some aspects, agitation of the beverage solution may be paused to allow foam to dissipate. It other aspects, agitation may be reduced to allow foam to dissipate. In further aspects, agitation may continue to incorporate foam into the beverage solution. It will be apparent to those skilled in the art that the first step of preparing ingredients can be performed in part during any pause taken.

The process further includes a fourth sequential step of adding soluble fiber to the volume. In some aspects, the fourth step is sequential to the first, second and third steps. In other aspects, the fourth step is at least sequential to the second step and the third step. In further aspects, the fourth step is sequential at least to the third step. In even further aspects, the fourth step is at least sequential to the second step.

Soluble fibers as included in a beverage as provided herein may include inulin, polydextrose and polydextrose polyols, fructooligosaccharide or oligofructose, mucilage, beta-glucans, pectin, gums, psyllium, resistant starch, wheat dextrin, or combinations thereof. In some aspects, the soluble fiber may include polydextrose, inulin, frutcooligosaccharides or combinations thereof. In other aspects, the soluble fiber is polydextrose.

In some aspects, the soluble fiber may be added to the beverage solution at a rate so as to provide for complete solubilization in the volume of the beverage solution. Those skilled in the art will appreciate that adding soluble fiber too quickly will hinder the fiber effectively dissolving in the volume solution and may provide for the presence of fiber sediment in the beverage solution. In some aspects, the soluble fiber may be added to the beverage solution at a rate of about 100 g/s. Those skilled in the art will appreciate that a slower rate may be acceptable. In some instances, the soluble fiber may be added at a rate of up to about 100 g/s. Those skilled in the art will appreciate that in some aspects, a slower rate may be acceptable, such as about 10, 20, 30, 40, 50, 60, 70, 80, or 90 g/s. Optionally, the rate of fiber addition may be maximized to limit exposure time of the beverage solution to ambient atmosphere. As set forth herein, the beverage produced by the process does not require pasteurization, sterilization or aseptic conditions, and as such, exposure to ambient atmosphere may, in some aspects, be kept to a minimum. Optionally, the fibers are soluble to the point to over about 90% will dissolve in the beverage solution. Optionally, the fibers dissolve from about 90% to 100% within the beverage solution, including about 91%, 92%, 93%, 94%, 95%, 96%, 97%, 98% and 99%. Optionally, the fibers completely dissolve in the beverage solution, i.e. 100% of fiber added dissolves.

In further aspects, the processes of the present disclosure include a fifth step of adding citric acid or similar consumable acidic compound to the beverage solution, such as a citrus juice, tartaric acid, ascorbic acid or acetic acid. In some aspects, the fifth step is sequential to the first, second, third and fourth steps. In other aspects, the fifth step is at least sequential to the second step, third and fourth steps. In further aspects, the fifth step is sequential at least to the fourth step. In even further aspects, the fifth step is at least sequential to the third step. In even further aspects, the fifth step is at least sequential to the second step

In some aspects, citric acid or similar acid may added to lower the pH of the volume. Optionally, the added acidic compound is of a food or consumable quality or grade. In some aspects, citric acid or similar acid may added to lower the pH to a value of from about 3.6 to about 3.9, including 3.60, 3.61, 3.62, 3.63, 3.64, 3.65, 3.66, 3.67, 3.68, 3.69, 3.70, 3.71, 3.72, 3.73, 3.74, 3.75, 3.76, 3.77, 3.78, 3.79, 3.80, 3.81, 3.82, 3.83, 3.84, 3.85, 3.86, 3.87, 3.88, 3.89 and 3.90. In further aspects, the pH may be lowered to a value of from about 3.0 to about 4.1, including about 3.00, 3.01, 3.02, 3.03, 3.04, 3.05, 3.06, 3.07, 3.08, 3.09, 3.10, 3.11, 3.12, 3.13, 3.14, 3.15, 3.16, 3.17, 3.18, 3.19, 3.20, 3.21, 3.22, 3.23, 3.24, 3.25, 3.26, 3.27, 3.28, 3.29, 3.30, 3.31, 3.32, 3.33, 3.34, 3.35, 3.36, 3.37, 3.38, 3.39, 3.40, 3.41, 3.42, 3.43, 3.44, 3.45, 3.46, 3.47, 3.48, 3.49, 3.50, 3.51, 3.52, 3.53, 3.54, 3.55, 3.56, 3.57, 3.58, 3.59, 3.60, 3.61, 3.62, 3.63, 3.64, 3.65, 3.66, 3.67, 3.68, 3.69, 3.70, 3.71, 3.72, 3.73, 3.74, 3.75, 3.76, 3.77, 3.78, 3.79, 3.80, 3.81, 3.82, 3.83, 3.84, 3.85, 3.86, 3.87, 3.88, 3.89, 3.90, 3.91, 3.92, 3.93, 3.94, 3.95, 3.96, 3.97, 3.98, 3.99, 4.00, 4.01, 4.02, 4.03, 4.04, 4.05, 4.06, 4.07, 4.08, 4.09, and 4.10.

It was identified that in a beverage as provided herein a pH lower than 3.6 may degrade the mushroom extract or fermented glycolipid byproduct/extract of mushroom. Optionally, a pH of lower than about 3.6 may inhibit activity of the mushroom extract. Further, it was identified that in a beverage as provided herein, a pH over 3.9 may provide for microbial growth. As described herein, the beverage solution may contain multiple nutrients, and as such, may attract and/or allow the growth of microorganisms, such as bacteria and fungus, to grow and/or culture during shelf storage. It was found that a bottled beverage or a beverage solution as provided herein with a pH of about 3.9 or lower may inhibit or prohibit microbial growth and/or reproduction therein. In other aspects, a bottled beverage or beverage solution containing the mushroom extract as described herein with a pH of about 3.9 or lower may inhibit or prohibit microbial growth and/or reproduction therein. In further aspects, a bottled beverage or beverage solution containing the mushroom extract as described herein with a pH of about 3.9 to about 3.6 may inhibit or prohibit microbial growth and/or reproduction therein.

Optionally, once the mushroom extract, soluble fiber, and citric acid are added to the beverage solution, the process of the present disclosure may include one, two or three additional steps that may occur in any order or in combination or combinations. In some aspects, the one, two or three additional steps may be in any order following at least the fifth step as set forth herein to provide a sixth, seventh, eighth and so on step. In other aspects, the one, two or three additional steps may be in any order following at least the fourth and the fifth step as set forth herein. In other aspects, the one, two or three additional steps may be in any order following at least the third, fourth and fifth steps as set forth herein. In further aspects, the one, two or three additional steps may be in any order following at least the second, third, fourth and fifth steps as set forth herein.

In some aspects, the additional steps may number four or more. Optionally, the one, two, three, four or more additional steps may include adding soluble vitamins and/or minerals, adding sweeteners and/or adding aromas and/or flavorings.

In some aspects, an additional step following the fifth step may include adding soluble vitamins and minerals, such as vitamin A, vitamin B3, vitamin B5, vitamin B6, vitamin B9, vitamin B12, vitamin C, vitamin D, vitamin E, vitamin K, thiamin, riboflavin, pantothenic acid, biotin, choline, calcium, chromium, copper, fluoride, iodine, iron, magnesium, manganese, molybdenum, phosphorous, selenium, zinc, potassium, sodium, and chloride. In certain aspects, only soluble vitamins are added. Optionally, soluble vitamins may include vitamins B3, B5, B6 and/or B9. In some aspects, soluble vitamins may include niacin, pyridoxine, pantothenate and folic acid.

As provided herein, the one, two, three, four or more optional additional steps may include adding sweeteners. Sweeteners may include sugar, glucose, fructose, galactose, sucrose, honey, agave, erythritol, monk fruit, stevia, allulose, deionized grape juice, coconut palm sugar, maple syrup, sucralose, aspartame, saccharin or combinations thereof. Optionally, sweeteners may include stevia, aspartame and/or sodium saccharin. In certain aspects, the sweetener is a stevia and/or a steviol glycoside, such as rebaudioside A.

As provided herein, the one, two, three, four or more optional additional steps may include adding aromas and/or flavors. Aromas may include NSF-09. Optionally, a flavoring may include pineapple, mint, pomegranate, orange, lime, passion fruit, apple, papaya, peach, hog-plum, mango, strawberry, hibiscus, grape, banana, peach, apricot, grapefruit, blueberry, cranberry, kiwi, lemon, coconut, watermelon, cherry, raspberry or combinations thereof. Optionally, the flavor is a combination of strawberry and kiwi.

Following the addition of mushroom extract, soluble fiber and citric acid, other components may be added in a specific sequence. For example, folic acid is added in a sixth step, followed by vitamins B5, B3 and B9 in a seventh step, followed by sweetener such as stevia in a seventh step and then aromas and flavorings in a single eighth step or in separate eighth and ninth steps.

In some aspects, following at least the fifth step and in some instances the step of adding aromas and/or flavorings and/or vitamins and/or adding sweeteners, the volume may be homogenized. In some aspects, the volume is homogenized by continuing to agitate the solution for a period of time, such as for about 15 mins to about 30 mins, including about 16, 17, 18, 19, 20, 21, 22, 23, 24, 25, 26, 27, 28 and 29 minutes.

In further aspects, following homogenization, the pH and/or Brix value and/or acidity may be assessed or evaluated to determine if the solution is ready for bottling.

The beverage solution as provided herein may have a Brix value, or sugar content value, of from about 2.4 to about 2.7 °Bx. Optionally, the solution has an acidity value of from about 0.05 to about 0.07 g/L. Following analyzation of the pH and/or Brix and/or acidity of the solution, in some aspects, the values can be adjusted to achieve the desired value by adding in required sugars or further citric acid or other acceptable acid solution and re-homogenized. In other aspects, an food grade acceptable alkali may be added to bring the final pH from about 3.6 to about 3.9. In further aspects, the beverage solution may be diluted with additional water to reduce a Brix value or sugar content value.

Once the beverage solution meets one or two or all of the quality standards, if desired, the solution may proceed to bottling. In some aspects, the solution is bottled through a filter, such as a filter of about 2 microns to about 100 microns. Optinally, the filter is of about 2 microns to about 10 microns.

In other aspects, an antimicrobial agent may be further added either to each bottle or in the beverage solution prior to bottling. The antimicrobial may be a dimethyldicarbonate (DMDC) compound, such as Velcorin. The antimicrobial agent may be added to about 120 to about 250 ppm. Optionally, the antimicrobial is present at about 125 ppm. Optionally, the antimicrobial is present at about 238 ppm. In some instances, adding 10 mL/hL of DMDC may provide about 125 ppm. In other aspects, adding 19 mL/hL may provide about 238 ppm.

The process described herein provides a non-refrigerated, shelf-stable (i.e. at room temperature (RT)), high in fiber infused or enriched beverage produced without pasteurization, or the inclusion of a high cost of an aseptic line, or the need for conservatives/preservatives.

The beverage solution prepared by the processes as described herein result in a soluble fiber beverage. As described herein, suitable soluble fibers in the soluble fiber beverage may include inulin, polydextrose and polydextrose polyols, fructooligosaccharide or oligofructose, mucilage, beta-glucans, pectin, gums, psyllium, resistant starch, wheat dextrin, or combinations thereof. In some aspects, the soluble fiber added may be selected from polydextrose, inulin and/or fructooligosaccharide. In other aspects, the soluble fiber may be polydextrose.

In further aspects, the soluble fiber present in the soluble fiber beverage at an amount of from about 10 g/L to about 20 g/L, including about 11, 12, 13, 14, 15, 16, 17, 18, and 19 g/L. In some aspects, the soluble fiber beverage has about 15 g/L of soluble fiber therein. As set forth herein, in may, in some aspects, be necessary to account for a loss of about 10% of soluble fiber in preparing the soluble fiber beverage. Those skilled in the art will appreciate that the process to produce the soluble fiber beverage may require additional soluble fiber to obtain a final desired concentration.

In some aspects, the base of the soluble fiber beverage is water. Sources for the water used in the soluble fiber beverage may include water added filtered, distilled, spring, RO, or combinations thereof. In other aspects, the water is potable water. In certain aspects, the soluble fiber beverage contains reverse osmosis water. In other certain aspects, the soluble fiber beverage contains spring water.

In some aspects, the soluble fiber beverage contains vitamins and/or minerals. Examples of vitamins and minerals may include vitamin A, vitamin B3, vitamin B5, vitamin B6, vitamin B9, vitamin B12, vitamin C, vitamin D, vitamin E, vitamin K, thiamin, riboflavin, pantothenic acid, biotin, choline, calcium, chromium, copper, fluoride, iodine, iron, magnesium, manganese, molybdenum, phosphorous, selenium, zinc, potassium, sodium, and chloride. In certain aspects, vitamins prepare to be added to the beverage solution may include vitamin B9 (folic acid), vitamin B6 (pyridoxine), vitamin B3 (niacin) and vitamin B5 (calcium pantothenate). In some aspects, vitamin B9 is present in the soluble fiber beverage at about 0.2 g/1000 L or 0.2 mg/L. In other aspects, vitamin B5 is present in the soluble fiber beverage at about 3.9 g/1000 L or 3.6 mg/L. In further aspects, vitamin B3 is present in the soluble fiber beverage at about 12.3 g/1000 L or 12.3 mg/L. In other aspects, vitamin B6 is present in the soluble fiber beverage at about 1.025 g/1000 L.

In further aspects, the soluble fiber beverage contains at least one sweetener. Suitable sweeteners may include sugar, glucose, fructose, galactose, sucrose, honey, agave, erythritol, monk fruit, stevia, steviol glycosides, allulose, deionized grape juice, coconut palm sugar, maple syrup, sucralose, aspartame, saccharin or combinations thereof. In some aspects, the sweeteners present is a stevia, aspartame or sodium saccharin. In further aspects, the sweetener present in the soluble fiber beverage is rebaudioside A. In some aspects, the sweetener is present in the soluble fiber beverage at about 65.625 g/1000 L or 65.625 mg/L. In some aspects, the soluble fiber beverage contains 65.625 mg/L.

In further aspects, the soluble fiber beverage contains an aroma or an aroma-masking agent to reduce or disguise the aroma of the soluble fiber beverage or provide a particular aroma to the soluble fiber beverage. In some aspects, such agents may provide a sweet aroma, so that fewer sweeteners are required for palatability. In some aspects, the aroma masking agents NSF-09 is present in the soluble fiber beverage at about 24.61 g/1000 L or 24.61 mg/L.

In further aspects, the soluble fiber beverage contains a flavoring. In some aspects, a flavoring is present in the soluble fiber beverage at about 1.025 kg/1000 L or 1.025 g/L. In some aspects, a flavoring agent may include fruit juices, extracts or artificial fruit flavors. In some aspects, the flavor may be selected from pineapple, mint, pomegranate, orange, lime, passion fruit, apple, papaya, peach, hog-plum, mango, strawberry, hibiscus, grape, banana, peach, apricot, grapefruit, blueberry, cranberry, kiwi, lemon, hibiscus, coconut, watermelon, cherry, raspberry or combinations thereof. In other aspects, the flavor is a combination of strawberry and kiwi.

In further aspects, the soluble fiber beverage contains a mushroom extract. In some aspects, the mushroom extract is the product Nagardo by LANXESS. In some aspects, the mushroom extract is a fermented extract from a mushroom source. In some aspects, the mushroom source may include basidiomycetes, including Dacrymycetes. In further aspects, the mushroom source may include fungus from the genus of Dacryopinax, including Dacryopinax spathularia. In other aspects, the mushroom extract includes glycolipids from a mushroom source, such as glycolipids from Dacryopinax spathularia. In further aspects, the mushroom extract includes fermented glycolipids from a mushroom source, such as fermented glycolipids from Dacryopinax spathularia. In certain aspects, the mushroom extract is present in the soluble fiber beverage at about 2 to about 8 ppm, including about 2, 3, 4, 5, 6, 7, and 8 ppm. In other aspects, a fermented glycolipid extract from Dacryopinax spathularia is present in the soluble fiber beverage at about 3 ppm.

In further aspects, the soluble fiber beverage contains a pH reducing or buffering agent, such as citric acid or a similar pH reducing agent, such as a citrus juice, tartaric acid, ascorbic acid or acetic acid. In some aspects, sufficient acids are present in the soluble fiber beverage to obtain a final pH of between about 3.6 to about 3.9. In other aspects, the soluble fiber beverage contains a pH reducing or buffering agent to obtain a final pH of between about 3.0 to about 4.1. In some aspects, about 646 mg/l L of citric acid is present in the soluble fiber beverage to provide the soluble fiber beverage with a pH of from about 3.6 to about 3.9. Those skilled in the art will appreciate that as set forth herein, further acidic compounds may be included to provide a soluble fiber beverage with a pH from about 3.6 to about 3.9.

In further aspects, the soluble fiber beverage contains an antimicrobial agent, such as a dimethyldicarbonate (DMDC) compound. In certain aspects, the DMDC compound is Velcorin. In some aspects, the antimicrobial agent is present in the soluble fiber beverage at about 120 to about 250 ppm. In some aspects, the antimicrobial is present at about 125 ppm. In other aspects, the antimicrobial is present at about 238 ppm.

The processes and the resulting soluble fiber beverage disclosed herein provide certain improvements and advantages over current processes and resulting products. For example, production of other beverages requires at least one of three of the following to provide a safe, consumer beverage that is a non-refrigerated shelf stable product:
Hot Fill: Bottling temperature is high and requires glass bottles or heavy plastic bottles to support the high temperature. In this case, the solution has to be heated and cannot be bottled at room temperature. Once the bottle is filled and capped, then the product is cooled to complete pasteurization.
Aseptic Filling: This process requires a special bottling line to avoid contact of the solution with air, since this line is used to obtain products that don’t use preservatives/conservatives. This bottling process is expensive, and it is done in a closed sterile environment. However, to eliminate organic growth, the solution must also be pasteurized prior to filling.
Cold Fill: This process requires preservatives/conservatives (e.g. benzoate and sorbate) to maintain the product shelf stable at room temperature. To eliminate organic growth, the solution must also be pasteurized prior to filling.

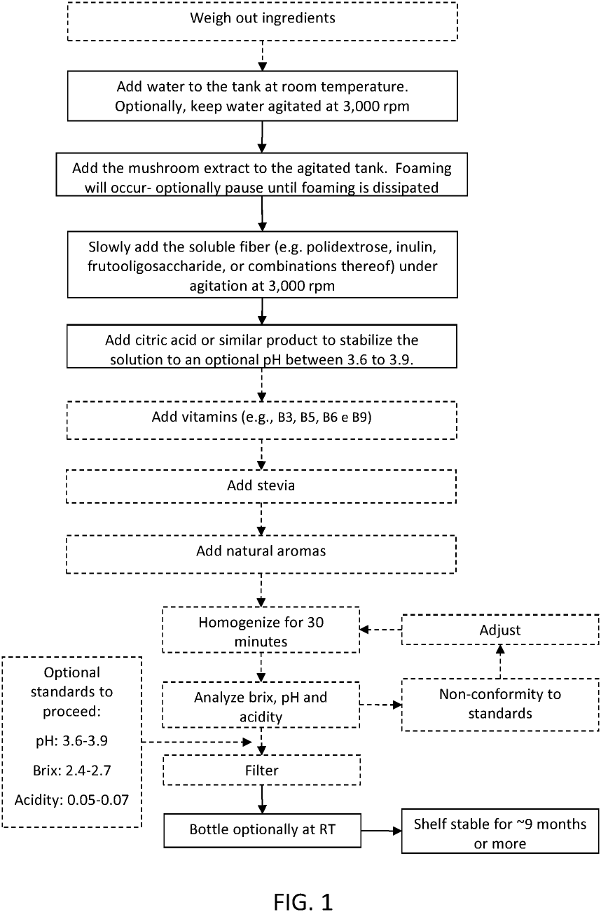

In contrast, the process of the present disclosure provides a simpler and faster process. The process includes, in some aspects, mixing all ingredients directly in a bottling tank, as demonstrated by FIG. 1. In some aspects, the process of the present disclosure eliminates any need for application or use of a pasteurizer, a cooling tunnel, an aseptic line or coincident heavy bottles, and/or preservatives/conservatives. The process of the present disclosure achieves the stability and shelf life by adding mushroom extract and/or obtaining a pH of from about 3.6 to about 3.9. In further aspects, the process provides a beverage that does not require refrigeration, and does not require refrigerated shelves at the point of sale.

In further aspects, the present disclosure provides a soluble fiber beverage that is not pasteurized. Optionally, the present disclosure provides a soluble fiber beverage that does not require a cooling tunnel to produce. In other aspects, the present disclosure provides a soluble fiber beverage that does not require an aseptic line to produce. In some aspects, the present disclosure provides a soluble fiber beverage that does not require coincident heavy bottles. In other aspects, the present disclosure provides a soluble fiber beverage that does not require preservatives and/or conservatives, or in other aspects, additional preservatives and/or conservatives other than those disclosed herein.

In some aspects, the beverage product is stable at room temperature for over a period of three months or more, optionally 6 months or more, optionally 9 months or more. In some aspects, the beverage product includes mushroom extract, soluble fiber, vitamins B3, B5, B6, B9, citric acid, rebaudioside A, aroma masking NSF-09 and flavor are in the beverage. In other aspects, DMDC is also present in the beverage, such as at about 125 or about 238 ppm. In some aspects, the flavor is a strawberry/kiwi flavor. In other aspects, the soluble fiber is polydextrose. In certain aspects, the beverage provides about 0.2 mg/L of folic acid, 3.8 mg/L of vitamin B5, 12 mg/L of vitamin B3, 1 mg/L of vitamin B6, 630 mg/L of citric acid, 64 mg/L of rebaudioside A, 24 mg/L of aroma masking NSF-09, 1 g/L of flavor such as strawberry/kiwi and about 15 to about 17 g/L of polydextrose or other soluble fiber. In certain aspects, the beverage is of about 975 mL of water for every liter of beverage.

In particular aspects, the beverage ingredient may be acquired accordingly: polydextrose may be provided as Litesse Ultra Powder IP by Danisco; D-calcium pantothenate may be provided as by Xinfa Pharmaceuticals; Nutra-B folic acid 10% may be provided by Glandia; citric acid may be provided by Jungbunzlaur; Nagardo (mushroom extract) and Velcorin (DMDC) may be provided by LANXESS, Natural Flavors may be provided by Dohler, Pyridoxine HCl may be provided by Jiangxi Tianxin Pharmaceutical Co.; and, Stevia RA80% may be provided by Pana Source.

The process of preparing the beverage product results only in a decrease of about 10% of fiber from all ingredients added due to dissolving over some carbohydrates therein. Due to the lack of high temperature exposure, no carbohydrates present are burned or caramelized during the process and are thus absent from the beverage product. Further, due to the ability to maintain the beverage at an ambient or room temperature, there is to be expected minimal exposure to extreme temperatures and accordingly an absence of associated side effects such as cross-linking, degradation, precipitation, and similar. In some aspects, the beverage product contains citric acid or a similar and has a pH from about 3.6 to about 3.9.

By way of example, products that are not pasteurized and don’t use preservatives/conservatives must be refrigerated. These products need refrigerated logistics, must be sold in refrigerated shelves, and have a short shelf life. Overall, these processes add cost that make production expensive and increase consumer cost. Conversely, the beverage product of the present disclosure is not pasteurized, yet further does not require refrigeration, does not require refrigerated logistics or does not need to be sold in refrigerated shelves. These features of the beverage product provide a cost-saving improvement that can benefit production efficiency and reduce consumer financial burden.

A first aspect of the present disclosure, either alone or in combination with any other aspect includes a process for producing a soluble fiber beverage comprising the ordered steps of: a) providing to a receptacle a volume of potable water; b) adding a mushroom extract to the volume; c) adding a soluble fiber to the volume; and d) adding an acidic component, wherein the process does not include pasteurization or refrigeration at 4° C. or lower.

A second aspect of the present disclosure, either alone or in combination with any other aspect includes the process of the first aspect, wherein the mushroom extract comprises a fermented extract from Dacryopinax spathularia.

A third aspect of the present disclosure, either alone or in combination with any other aspect includes the process of the first or second aspect, wherein the mushroom extract is added to the volume at a concentration of about 2 to about 8 parts per million (ppm).

A fourth aspect of the present disclosure, either alone or in combination with any other aspect includes the process of the third aspect, wherein the mushroom extract is added to the volume at a concentration of 3 ppm.

A fifth aspect of the present disclosure, either alone or in combination with any other aspect includes the process of the first aspect, wherein the volume is agitated after step a).

A sixth aspect of the present disclosure, either alone or in combination with any other aspect includes the process of the fifth aspect, wherein the volume is agitated at a rate of about 1500 revolutions per minute (rpm) to about 3500 rpm.

A seventh aspect of the present disclosure, either alone or in combination with any other aspect includes the process of the sixth aspect, wherein the volume is agitated at a rate of 300 rpm.

An eighth aspect of the present disclosure, either alone or in combination with any other aspect includes the process of the first aspect, wherein a pause is introduced between steps b) and c) to allow for dissipation of foam.

A ninth aspect of the present disclosure, either alone or in combination with any other aspect includes the process of the eighth aspect, wherein the pause is of about 10 to about 20 minutes.

A tenth aspect of the present disclosure, either alone or in combination with any other aspect includes the process of the ninth aspect, wherein the pause is about 15 minutes.

An eleventh aspect of the present disclosure, either alone or in combination with any other aspect includes the process of the first aspect, wherein the soluble fiber is selected from the group consisting of inulin, polydextrose and polydextrose polyols, fructooligosaccharide or oligofructose, mucilage, beta-glucans, pectin, gums, psyllium, resistant starch, wheat dextrin, or combinations thereof.

A twelfth aspect of the present disclosure, either alone or in combination with any other aspect includes the process of the first or eleventh aspect, wherein the soluble fiber is selected from the group consisting of polydextrose, inulin, fructooligosaccharide or combinations thereof.

A thirteenth aspect of the present disclosure, either alone or in combination with any other aspect includes the process of the first or eleventh aspect, wherein the soluble fiber is polydextrose.

A fourteenth aspect of the present disclosure, either alone or in combination with any other aspect includes the process of the first or eleventh, wherein 16.6 kg of soluble fiber is added for every 1000 liters of water.

A fifteenth aspect of the present disclosure, either alone or in combination with any other aspect includes the process of the first aspect, wherein the acidic component is selected from the group consisting of citric acid, citrus juice, tartaric acid, ascorbic acid, acetic acid or combinations thereof.

A sixteenth aspect of the present disclosure, either alone or in combination with any other aspect includes the process of the fifteenth aspect, wherein the acidic component is citric acid.

A seventeenth aspect of the present disclosure, either alone or in combination with any other aspect includes the process of the sixteenth aspect, wherein about 646 g of the citric acid is added for every 1000 liters of beverage solution.

An eighteenth aspect of the present disclosure, either alone or in combination with any other aspect includes the process of the fifteenth aspect, wherein the acidic component is added until a pH of about 3.6 to about 3.9 is obtained.

A nineteenth aspect of the present disclosure, either alone or in combination with any other aspect includes the process of the first, second, fifth, eighth, eleventh or fifteenth aspect, wherein the water is obtained by reverse osmosis, distillation or a spring.

A twentieth aspect of the present disclosure, either alone or in combination with any other aspect includes the process of the first, second, fifth, eighth, eleventh, or fifteenth aspect, further comprising one or more additional steps after d).

A twenty-first aspect of the present disclosure, either alone or in combination with any other aspect includes the process of the twentieth aspect, wherein the one or more additional steps comprise adding a sweetener.

A twenty-second aspect of the present disclosure, either alone or in combination with any other aspect includes the process of the twenty-first aspect, wherein the sweetener is selected from the group consisting of sugar, glucose, fructose, galactose, sucrose, honey, agave, erythritol, monk fruit, stevia, allulose, deionized grape juice, coconut palm sugar, maple syrup, sucralose, aspartame, saccharin or combinations thereof.

A twenty-third aspect of the present disclosure, either alone or in combination with any other aspect includes the process of the twenty-first aspect, wherein the sweetener comprises a stevia.

A twenty-fourth aspect of the present disclosure, either alone or in combination with any other aspect includes the process of the twenty-third aspect, wherein the stevia comprises rebaudioside A.

A twenty-fifth aspect of the present disclosure, either alone or in combination with any other aspect includes the process of the twenty-first aspect, wherein about 65.625 g of the sweetener is added for every 1000 liters of water.

A twenty-sixth aspect of the present disclosure, either alone or in combination with any other aspect includes the process of the twentieth aspect, wherein the one or more additional steps comprise adding a flavoring agent and/or an aroma agent.

A twenty-seventh aspect of the present disclosure, either alone or in combination with any other aspect includes the process of the twenty-sixth aspect, wherein the flavoring agent is selected from the group consisting of pineapple, mint, pomegranate, orange, lime, passion fruit, apple, papaya, peach, hog-plum, mango, strawberry, hibiscus, grape, banana, peach, apricot, grapefruit, blueberry, cranberry, kiwi, lemon, hibiscus, coconut, watermelon, cherry, raspberry or combinations thereof. In other aspects, the flavor is a combination of strawberry, kiwi or combinations thereof.

A twenty-eighth aspect of the present disclosure, either alone or in combination with any other aspect includes the process of the twenty-sixth aspect, wherein the aroma agent is an aroma masking agent.

A twenty-ninth aspect of the present disclosure, either alone or in combination with any other aspect includes the process of the twenty-sixth aspect, wherein the aroma agent comprises NSF-09.

A thirtieth aspect of the present disclosure, either alone or in combination with any other aspect includes the process of the twenty-ninth aspect, wherein 24.61 g of NSF-09 is added for every 1000 liters of water.

A thirty-first aspect of the present disclosure, either alone or in combination with any other aspect includes the process of the twentieth aspect, wherein the one or more additional steps comprise adding at least one vitamin.

A thirty-second aspect of the present disclosure, either alone or in combination with any other aspect includes the process of the thirty-first aspect, wherein the at least one vitamin is selected from the group consisting of vitamin A, vitamin B3, vitamin B5, vitamin B6, vitamin B9, vitamin B12, vitamin C, vitamin D, vitamin E, vitamin K, thiamin, riboflavin, pantothenic acid, biotin, choline, calcium, chromium, copper, fluoride, iodine, iron, magnesium, manganese, molybdenum, phosphorous, selenium, zinc, potassium, sodium, chloride or combinations thereof.

A thirty-third aspect of the present disclosure, either alone or in combination with any other aspect includes the process of the thirty-first aspect, wherein the at least one vitamin is selected from the group consisting of vitamin B9 (folic acid), vitamin B6 (pyridoxine), vitamin B3 (niacin), vitamin B5 (calcium pantothenate) or combinations thereof.

A thirty-fourth aspect of the present disclosure, either alone or in combination with any other aspect includes the process of the thirty-first aspect, wherein the at least one vitamin comprises vitamin B9 (folic acid), vitamin B6 (pyridoxine), vitamin B3 (niacin) and vitamin B5 (calcium pantothenate).

A thirty-fifth aspect of the present disclosure, either alone or in combination with any other aspect includes the process of the thirty-fourth aspect, wherein about 0.2 g of vitamin B9 is added for every 1000 liters of water.

A thirty-sixth aspect of the present disclosure, either alone or in combination with any other aspect includes the process of the thirty-fourth aspect, wherein about 3.9 g of vitamin B5 is added for every 1000 liters of water.

A thirty-seventh aspect of the present disclosure, either alone or in combination with any other aspect includes the process of the thirty-fourth aspect, wherein about 12.3 g of vitamin B3 is added for every 1000 liters of water.

A thirty-eighth aspect of the present disclosure, either alone or in combination with any other aspect includes the process of the thirty-fourth aspect, wherein about 1.025 g of vitamin B6 is added for every 1000 liters of water.

A thirty-ninth aspect of the present disclosure, either alone or in combination with any other aspect includes the process of the twentieth aspect, wherein pH of the soluble fiber beverage is checked or adjusted to be of about 3.6 to about 3.9.

A fortieth aspect of the present disclosure, either alone or in combination with any other aspect includes the process of the twentieth aspect, wherein Brix value of the soluble fiber beverage is checked or adjusted to be of about 2.4 to about 2.7.

A forty-first aspect of the present disclosure, either alone or in combination with any other aspect includes the process of the twentieth aspect, wherein acidity value of the soluble fiber beverage is checked or adjusted to be of about 0.05 to about 0.07.

A forty-second aspect of the present disclosure, either alone or in combination with any other aspect includes the process of the first, second, fifth, eighth, eleventh, or fifteenth aspect, further comprising adding dimethyldicarbonate (DMDC).

A forty-third aspect of the present disclosure, either alone or in combination with any other aspect includes the process of the forty-second aspect, wherein DMDC is added at a concentration of about 125 to about 238 ppm

A forty-fourth aspect of the present disclosure, either alone or in combination with any other aspect includes a soluble fiber beverage comprising about 0.2 mg/L of folic acid, 3.8 mg/L of vitamin B5, 12 mg/L of vitamin B3, 1 mg/L of vitamin B6, 630 mg/L of citric acid, 64 mg/L of rebaudioside A, 24 mg/L of aroma masking NSF-09, 1 g/L of a flavoring agent and about 15 to about 17 g/L of polydextrose or other soluble fiber, wherein the beverage is stable at room temperate and does not require refrigeration for a period of up to at least 3 months.

This description is merely exemplary in nature and is in no way intended to limit the scope of the invention, its application, or uses, which may, of course, vary. The compositions or processes are described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Any patents or publications mentioned in this specification are indicative of the levels of those skilled in the art to which the invention pertains. These patents and publications are herein incorporated by reference to the same extent as if each individual publication was specifically and individually indicated to be completely incorporated by reference.

1. A process for producing a soluble fiber beverage comprising the ordered steps of:
a) providing to a receptacle a volume of potable water;
b) adding a mushroom extract to the volume;
c) adding a soluble fiber to the volume; and
d) adding an acidic component,
wherein the process does not include pasteurization or refrigeration at 4° C. or lower.

2. The process of claim 1, wherein the mushroom extract comprises a fermented extract from Dacryopinax spathularia.

3. The process of claim 1 or 2, wherein the mushroom extract is added to the volume at a concentration of about 2 to about 8 parts per million (ppm).

4. The process of claim 3, wherein the mushroom extract is added to the volume at a concentration of 3 ppm.

5. The process of claim 1, wherein the volume is agitated after step a).

6. The process of claim 5, wherein the volume is agitated at a rate of about 1500 revolutions per minute (rpm) to about 3500 rpm.

7. The process of claim 6, wherein the volume is agitated at a rate of 3000 rpm.

8. The process of claim 1, wherein a pause is introduced between steps b) and c) to allow for dissipation of foam.

9. The process of claim 8, wherein the pause is of about 10 to about 20 minutes.

10. The process of claim 9, wherein the pause is about 15 minutes.

11. The process of claim 1, wherein the soluble fiber is selected from the group consisting of inulin, polydextrose or polydextrose polyols, fructooligosaccharide or oligofructose, mucilage, beta-glucans, pectin, gums, psyllium, resistant starch, wheat dextrin, and combinations thereof.

12. The process of claim 1 or 11, wherein the soluble fiber is selected from the group consisting of polydextrose, inulin, fructooligosaccharide or combinations thereof.

13. The process of claim 1 or 11, wherein the soluble fiber is polydextrose.

14. The process of claim 1 or 11, wherein 16.6 kg of soluble fiber is added for every 1000 liters of water.

15. The process of claim 1, wherein the acidic component is selected from the group consisting of citric acid, citrus juice, tartaric acid, ascorbic acid, acetic acid or combinations thereof.

16. The process of claim 15, wherein the acidic component is citric acid.

17. The process of claim 16, wherein about 646 grams of the citric acid is added for every 1000 liters of beverage solution.

18. The process of claim 15, wherein the acidic component is added until a pH of about 3.6 to about 3.9 is obtained.

19. The process of claim 1, 2, 5, 8, 11, or 15, wherein the water is obtained by reverse osmosis, distillation or a spring.

20. The process of claim 1, 2, 5, 8, 11, or 15, further comprising one or more additional steps after d).

21. The process of claim 20, wherein the one or more additional steps comprise adding a sweetener.

22. The process of claim 21, wherein the sweetener is selected from the group consisting of sugar, glucose, fructose, galactose, sucrose, honey, agave, erythritol, monk fruit, stevia, allulose, deionized grape juice, coconut palm sugar, maple syrup, sucralose, aspartame, saccharin or combinations thereof.

23. The process of claim 21, wherein the sweetener comprises a stevia.

24. The process of claim 23, wherein the stevia comprises rebaudioside A.

25. The process of claim 21, wherein about 65.625 grams of the sweetener is added for every 1000 liters of water.

26. The process of claim 20, wherein the one or more additional steps comprise adding a flavoring agent and/or an aroma agent.

27. The process of claim 26, wherein the flavoring agent is selected from the group consisting of pineapple, mint, pomegranate, orange, lime, passion fruit, apple, papaya, peach, hog-plum, mango, strawberry, hibiscus, grape, banana, peach, apricot, grapefruit, blueberry, cranberry, kiwi, lemon, hibiscus, coconut, watermelon, cherry, raspberry or combinations thereof. In other aspects, the flavor is a combination of strawberry, kiwi or combinations thereof.

28. The process of claim 26, wherein the aroma agent is an aroma masking agent.

29. The process of claim 26, wherein the aroma agent comprises NSF-09.

30. The process of claim 29, wherein 24.61 grams of NSF-09 is added for every 1000 liters of water.

31. The process of claim 20, wherein the one or more additional steps comprise adding at least one vitamin.

32. The process of claim 31, wherein the at least one vitamin is selected from the group consisting of vitamin A, vitamin B3, vitamin B5, vitamin B6, vitamin B9, vitamin B12, vitamin C, vitamin D, vitamin E, vitamin K, thiamin, riboflavin, pantothenic acid, biotin, choline, calcium, chromium, copper, fluoride, iodine, iron, magnesium, manganese, molybdenum, phosphorous, selenium, zinc, potassium, sodium, chloride or combinations thereof.

33. The process of claim 31, wherein the at least one vitamin is selected from the group consisting of vitamin B9 (folic acid), vitamin B6 (pyridoxine), vitamin B3 (niacin), vitamin B5 (calcium pantothenate) or combinations thereof.

34. The process of claim 31, wherein the at least one vitamin comprises vitamin B9 (folic acid), vitamin B6 (pyridoxine), vitamin B3 (niacin) and vitamin B5 (calcium pantothenate).

35. The process of claim 34, wherein about 0.2 grams of vitamin B9 is added for every 1000 liters of water.

36. The process of claim 34, wherein about 3.9 grams of vitamin B5 is added for every 1000 liters of water.

37. The process of claim 34, wherein about 12.3 grams of vitamin B3 is added for every 1000 liters of water.

38. The process of claim 34, wherein about 1.025 grams of vitamin B6 is added for every 1000 liters of water.

39. The process of claim 20, wherein pH of the soluble fiber beverage is checked or adjusted to be of about 3.6 to about 3.9.

40. The process of claim 20, wherein Brix value of the soluble fiber beverage is checked or adjusted to be of about 2.4 to about 2.7.

41. The process of claim 20, wherein acidity value of the soluble fiber beverage is checked or adjusted to be of about 0.05 to about 0.07.

42. The process of claim 1, 2, 5, 8, 11, or 15, further comprising adding dimethyldicarbonate (DMDC).

43. The process of claim 42, wherein DMDC is added at a concentration of about 125 to about 238 ppm.

44. A soluble fiber beverage comprising about 0.2 mg/L of folic acid, 3.8 mg/L of vitamin B5, 12 mg/L of vitamin B3, 1 mg/L of vitamin B6, 630 mg/L of citric acid, 64 mg/L of rebaudioside A, 24 mg/L of aroma masking NSF-09, 1 g/L of a flavoring agent and about 15 to about 17 g/L of polydextrose or other soluble fiber, wherein the beverage is stable at room temperate and does not require refrigeration for a period of up to at least 3 months.
